(19) United States
(12) Patent Application Publication
(10) Pub. No.: US 2023/0328139 A1
(43) Pub. Date: Oct. 12, 2023

(54) METHODS AND INTERNET OF THINGS SYSTEMS FOR PLATFORM INTELLIGENT STATEMENT BASED ON OPERATION OF SMART GAS

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Junyan ZHOU, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 18/332,678

(22) Filed: Jun. 9, 2023

(30) Foreign Application Priority Data
Apr. 10, 2023 (CN) 202310371938.3

(51) Int. Cl. H04L 67/12; G16Y 10/35; G16Y 40/35

(52) U.S. Cl. CPC H04L 67/12; G16Y 10/35; G16Y 40/35

(57) ABSTRACT

The present disclosure provides a method for platform intelligent statement based on operation of smart gas. The method is implemented by a smart gas management platform of an Internet of Things (IoT) system for platform intelligent statement based on operation of smart gas and includes: obtaining work order information of a target gas work order, the work order information including at least one of a gas user type, a work order type, a work order urgency, or work order correlation information; determining a statement demand degree of the target gas work order based on the work order information; determining a target statement parameter based on the statement demand degree, the target statement parameter including at least one of a statement mode, a statement time limit, or a statement verification parameter; and performing statement verification for a target handler based on the target statement parameter.

### CROSS-REFERENCE TO RELATED APPLICATION

This application claims priority to Chinese Patent Application No. 202310371938.3, filed on Apr. 10, 2023, and the entire contents of which are hereby incorporated by reference.

### TECHNICAL FIELD

The present disclosure relates to the technical field of gas work order management and an Internet of Things (IoT), and in particular, to methods and Internet of Things (IoT) systems for platform intelligent statement based on operation of smart gas.

### BACKGROUND

The assignment of gas work order tasks and the scheduling of staff are indispensable management matters in gas operation. Supervising the execution of gas work orders is an important link in operation management. A count of residents served by gas operation and a count of tasks of the gas pipeline network are extremely large. With the increase of tasks such as gas repair, maintenance, and gas user services, the execution of gas work orders has an important influence on the operation of the entire gas pipeline network and customer satisfaction. In particular, the gas work order is not completed in time and the statement is not made in time, which may have a negative influence on the arrangement, execution, and scheduling of subsequent related work tasks, and the production and life of gas users and, more seriously, may affect the normal operation of the entire gas pipeline network.

Therefore, it is desirable to provide a method and an Internet of Things (IoT) system for platform intelligent statement based on operation of smart gas, which can help to effectively manage and control the execution and statement of gas work orders, strengthen the supervision of the execution of gas work orders, and improve the management efficiency of the gas pipeline network for the gas work orders.

### SUMMARY

One of the embodiments of the present disclosure provides a method for platform intelligent statement based on operation of smart gas. The method is implemented by a smart gas management platform of an Internet of Things (IoT) system for platform intelligent statement based on operation of smart gas and includes: obtaining work order information of a target gas work order, the work order information including at least one of a gas user type, a work order type, a work order urgency, or work order correlation information; determining a statement demand degree of the target gas work order based on the work order information; determining a target statement parameter based on the statement demand degree, the target statement parameter including at least one of a statement mode, a statement time limit, or a statement verification parameter; and performing statement verification for a target handler based on the target statement parameter.

One of the embodiments of the present disclosure provides an Internet of Things (IoT) system for platform intelligent statement based on operation of smart gas. The IoT system includes a smart gas user platform, a smart gas service platform, a smart gas management platform, a smart gas sensor network platform, and a smart gas object platform. The smart gas management platform may be configured to: obtain work order information of a target gas work order, the work order information including at least one of a gas user type, a work order type, a work order urgency, or work order correlation information; determine a statement demand degree of the target gas work order based on the work order information; determine a target statement parameter based on the statement demand degree, the target statement parameter including at least one of a statement mode, a statement time limit, or a statement verification parameter; and perform statement verification for a target handler based on the target statement parameter.

One of the embodiments of the present disclosure provides a non-transitory computer-readable storage medium storing computer instructions. After reading the computer instructions in the storage medium, a computer may execute the method for platform intelligent statement based on operation of smart gas.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, wherein:

FIG. 1 is a schematic diagram illustrating an exemplary Internet of Things (IoT) system for platform intelligent statement based on operation of smart gas according to some embodiments of the present disclosure;

FIG. 2 is flowchart illustrating an exemplary process for platform intelligent statement based on operation of smart gas according to some embodiments of the present disclosure;

FIG. 3 is flowchart illustrating an exemplary process for determining a statement demand degree of a target gas work order according to some embodiments of the present disclosure;

FIG. 4 is flowchart illustrating an exemplary process for determining a statement influenced object of a target gas work order according to some embodiments of the present disclosure;

FIG. 5 is flowchart illustrating an exemplary process for determining a statement parameter of a target gas work order according to some embodiments of the present disclosure;

FIG. 6a is flowchart illustrating an exemplary process for determining a correlation influence degree according to some embodiments of the present disclosure; and

FIG. 6b is schematic diagram illustrating an exemplary process for determining a correlation influence degree according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiment of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

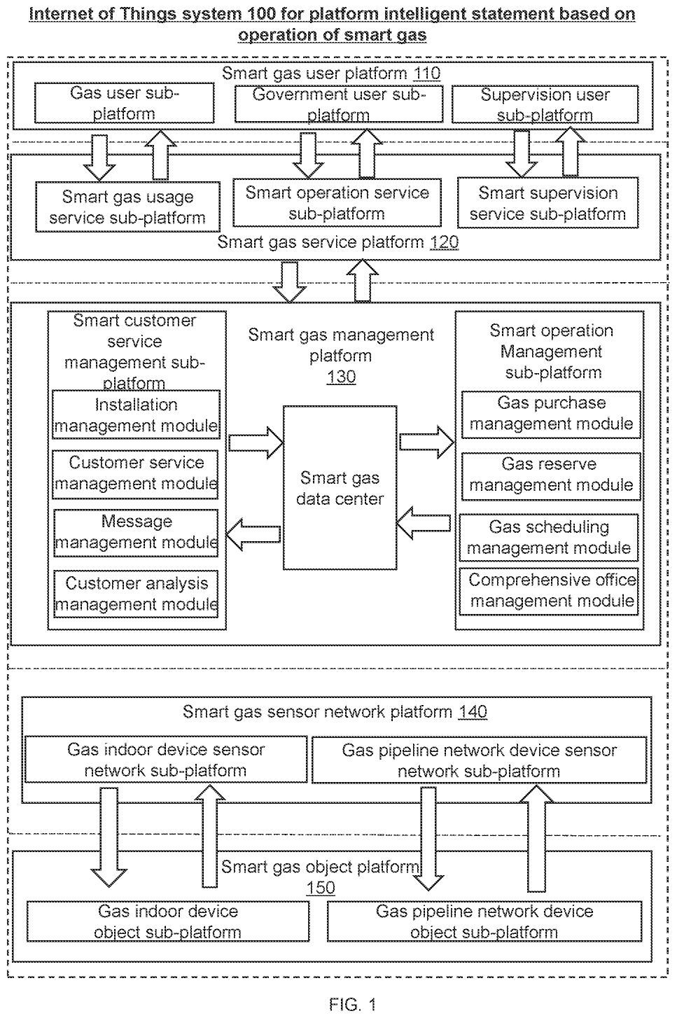

FIG. 1 is a schematic diagram illustrating an exemplary Internet of Things (IoT) system for platform intelligent statement based on operation of smart gas according to some embodiments of the present disclosure. The IoT system for platform intelligent statement based on operation of smart gas involved in some embodiments of the present disclosure is illustrated in detail below. It should be noted that the following embodiments are only used to explain the present disclosure and do not constitute a limitation of the present disclosure.

The IoT system may be an information processing system including some or all of a user platform, a service platform, a management platform, a sensor network platform, and an object platform. The user platform may be a functional platform that implements user perceptual information obtaining and control information generation. The service platform may implement connection between the management platform and the user platform and play functions of perceptual information service communication and control information service communication. The management platform may overall plan and coordinate connection and collaboration between various functional platforms (e.g., the user platform and the service platform). The management platform may gather information of an IoT operating system and may provide functions of perception management and control management for the IoT operating system. The sensor network platform may be a functional platform for managing sensor communication. In some embodiments, the sensor network platform may connect the management platform and the object platform and realize functions of perceptual information sensor communication and control information sensor communication. The object platform may be a functional platform for perceptual information generation and control information execution.

In some embodiments, when the IoT system is applied to gas management, the IoT system may be referred to as a smart gas IoT system.

In some embodiments, as shown in FIG. 1, the IoT system 100 for platform intelligent statement based on operation of smart gas (hereinafter referred to as the IoT system 100) may include a smart gas user platform 110, a smart gas service platform 120, a smart gas management platform 130, a smart gas sensor network platform 140, and a smart gas object platform 150.

The smart gas user platform 110 may be a platform configured to interact with a user. The user may be a gas user, a supervision user, a repairman of a gas company, an administrator of the gas company, etc. In some embodiments, the smart gas user platform 110 may be configured as a terminal device. For example, the terminal device may include a mobile device, a tablet computer, or the like, or any combination thereof. In some embodiments, the smart gas user platform 110 may be configured to receive information or an instruction. For example, the smart gas user platform 110 (e.g., a government user sub-platform) may obtain a statement situation of a gas work order through the terminal device. In some embodiments, the smart gas user platform 110 may send a request or an instruction input by the user to the smart gas service platform 120 and obtain information (e.g., the statement situation of the gas work order) fed back by the smart gas service platform 120.

In some embodiments, the smart gas user platform 110 may include a gas user sub-platform, a government user sub-platform, and a supervision user sub-platform.

The gas user sub-platform may correspond to a smart gas usage service sub-platform and may be configured to obtain feedback information from a gas user. The gas user may be an industrial gas user, a commercial gas user, an ordinary gas user (e.g., residential gas user), etc. The gas user may feedback fault information of a gas device, installation of a gas device, consultation, complaints, and opinions of gas problems, etc. through the gas user sub-platform. In some embodiments, the feedback information of the gas user may be used to generate a gas work order (e.g., a gas device repair work order).

The government user sub-platform may correspond to a smart operation service sub-platform and may be configured to obtain information related to the gas work order. A government user may be a manager (e.g., an administrator), a repairman, etc. of a gas operation entity. The government user sub-platform may feedback the information (e.g., a work order serial number, processing content of a work order, arrangement of a handler, an execution progress, a statement status, etc.) related to the gas work order to the government user.

The supervision user sub-platform may correspond to a smart supervision service sub-platform. In some embodiments, the supervision user may supervise and manage safety operation of the IoT system 100 through the supervision user sub-platform, to ensure safe and orderly operation of the IoT system 100.

The smart gas service platform 120 may be a platform configured to convey user's needs and control information and may be connected to the smart gas user platform 110 and the smart gas management platform 130. The smart gas service platform 120 may obtain the information (e.g., basic information, the execution progress, and the statement status of the gas work order) related to the gas work order from the smart gas management platform 130 (e.g., a smart gas data center) and send the information related to the gas work order to the smart gas user platform 110 (e.g., the government user sub-platform). In some embodiments, the smart gas service platform 120 may include a processing device and other components. The processing device may be a server or a server group.

In some embodiments, the smart gas service platform 120 may include a smart gas usage service sub-platform, a smart operation service sub-platform, and a smart supervision service sub-platform.

The smart gas usage service sub-platform may be a platform that provides a gas service for the gas user and may correspond to the gas user sub-platform. In some embodiments, the smart gas usage service sub-platform may send information such as a gas pipeline network maintenance notice and a gas usage abnormality reminder to the gas user sub-platform.

The smart operation service sub-platform may be a platform that provides information related to gas operation for the government user and may correspond to the government user sub-platform. In some embodiments, the smart operation service sub-platform may send the information related to gas operation management to the government user sub-platform. For example, the smart operation service sub-platform may obtain statistical information (e.g., a count of gas work orders, execution situation, the statement situation of the gas work order) of the gas work order from the smart gas management platform and send the statistical information of the gas work order to the government user sub-platform.

The smart supervision service sub-platform may be a platform that provides a supervision requirement to the supervision user and may correspond to the supervision user sub-platform. In some embodiments, the smart supervision service sub-platform may send safety management information of a gas pipeline network, abnormality information of a gas pipeline network, etc. to the supervision user sub-platform.

The smart gas management platform 130 refers to a platform that overall plans and coordinates the connection and collaboration between various functional platforms, gathers all the information of the IoT, and provides the functions of perception management and control management for the IoT operating system. In some embodiments, the smart gas management platform 130 may include a processing device and other components (e.g., a storage device). The processing device may be a server or a server group. In some embodiments, the smart gas management platform 130 may be a remote platform controlled by a user (e.g., a system administrator), artificial intelligence (AI), or a preset rule.

In some embodiments, the smart gas management platform 130 may include a smart customer service management sub-platform, a smart operation management sub-platform, and a smart gas data center.

The smart customer service management sub-platform may be a platform configured to process information related to the gas user. In some embodiments, the smart customer service management sub-platform may include, but is not limited to, an installation management module, a customer service management module, a message management module, and a customer analysis management module. The smart customer service management sub-platform may analyze and process the information related to the gas user through the aforementioned management modules. For example, the smart customer service management sub-platform may send a message of adding a gas work order, delaying a gas work order, a statement reminder of a gas work order, etc., to an operator of the gas work order and may also send a notification message such as a gas outage notice, a gas outage range to the gas user through the message management module.

The smart operation management sub-platform may be a platform configured to process the information related to gas operation and manage gas operation. In some embodiments, the smart operation management sub-platform may include, but is not limited to, management modules such as a gas purchase management module, a gas reserve management module, a gas scheduling management module, and a comprehensive office management module. The smart operation management sub-platform may analyze and process the information related to gas operation through the aforementioned management modules. In some embodiments, the smart operation management sub-platform may coordinate an operation affair such as human resources, public resources, gas devices, daily office, or administrative management through the comprehensive office management module. For example, for the delay of the execution, the delay of the statement, etc. of the gas work order, the smart operation management sub-platform may arrange assistants, strengthen a statement reminder frequency of the gas work order, etc.

The smart gas data center may be configured to store and manage all operation information of the IoT system 100. In some embodiments, the smart gas data center may be configured as a storage device (e.g., a database) for storing, including but not limited to, historical and current gas work order management data, gas pipeline network monitoring data, etc. For example, the smart gas data center may store a record, an execution progress, a statement status, etc. of a gas work order and may store an operation status of a gas device, gas usage of the gas user, etc. in the gas pipeline network.

In some embodiments, the smart gas management platform 130 may exchange information with the smart gas service platform 120 and the smart gas sensor network platform 140 respectively through the smart gas data center. For example, the smart gas data center may send information such as generation of gas work orders and arrangement of handlers to the smart gas service platform 120. As another example, the smart gas data center may send an instruction for obtaining operation information of a gas device to the smart gas sensor network platform 140 and receive the operation information of the gas device (e.g., indoor device and pipeline network device) uploaded by the smart gas sensor network platform 140. In some embodiments, the smart gas management platform 130 may generate a gas work order based on abnormality information of the gas device of the smart gas data center.

The smart gas sensor network platform 140 may be a functional platform configured to manage sensor communication. In some embodiments, the smart gas sensor network platform 140 may be connected to the smart gas management platform 130 and the smart gas object platform 150 to implement the functions of perceptual information sensor communication and control information sensor communication.

In some embodiments, the smart gas sensor network platform 140 may include a gas indoor device sensor network sub-platform and a gas pipeline network device sensor network sub-platform. The gas indoor device sensor network sub-platform may correspond to a gas indoor device object sub-platform and may be configured to obtain operation monitoring information of the gas indoor device (e.g., a gas meter of the gas user). The gas pipeline network device sensor network sub-platform may correspond to a gas pipeline network device object sub-platform and may be configured to obtain operation monitoring information of the gas pipeline network device (e.g., a gas pipeline, a valve control device, a gas gate station device, etc.).

The smart gas object platform 150 may be a functional platform for perceptual information generation and control information execution. For example, the smart gas object platform 150 may monitor and generate operation information of the gas indoor device and the gas pipeline network device and upload the operation information of the gas indoor device and the gas pipeline network device to the smart gas data center through the smart gas sensor network platform 140.

In some embodiments, the smart gas object platform 150 may include a gas indoor device object sub-platform and a gas pipeline network device object sub-platform. In some embodiments, the gas indoor device object sub-platform may be configured as various types of gas indoor devices of gas users, such as a gas meter, an indoor gas pipeline, etc. The gas pipeline network device object sub-platform may be configured as various types of gas pipeline network devices and monitoring devices. The gas pipeline network device may include an outdoor gas pipeline, a valve control device, a gas storage tank, a pressure regulation device, etc.; the monitoring device may include a gas flow meter, a pressure sensor, a temperature sensor, etc. In some embodiments, the gas indoor device object sub-platform and the gas pipeline network device object sub-platform may respectively send the operation information (e.g., operation fault information, operation risk information) of the gas indoor device and the gas pipeline network device to the smart gas data center through the smart gas sensor network sub-platform 140.

In some embodiments of the present disclosure, the IoT system for platform intelligent statement based on operation smart gas may form a closed loop of information operation between the smart gas object platform and the smart gas user platform, and coordinate and regularize operation under the unified management of the smart gas management platform, so as to implement informatization and intelligence of gas operation management.

It should be noted that the IoT system 100 is merely provided for the purpose of illustration and is not intended to limit the scope of the present disclosure. Those skilled in the art may make various modifications or alterations according to the description of the present disclosure. For example, the IoT system 100 may include one or more other appropriate components to perform similar or different functions. However, modifications and alterations do not depart from the scope of the present disclosure.

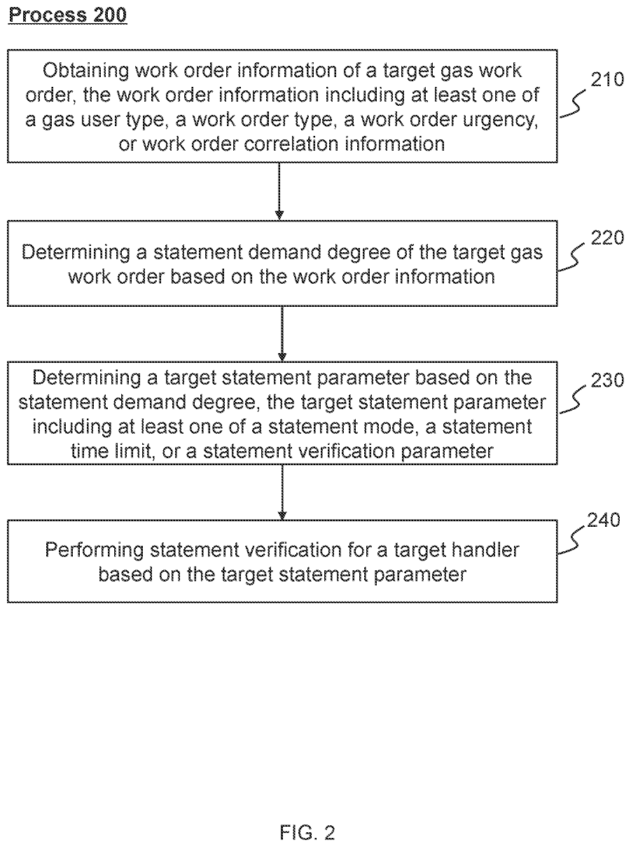

FIG. 2 is a flowchart illustrating an exemplary process for platform intelligent statement based on operation of smart gas according to some embodiments of the present disclosure.

In some embodiments, the process 200 may be performed by a smart gas management platform. As shown in FIG. 2, the process 200 may include the following operations.

In 210, work order information of a target gas work order may be obtained, the work order information including at least one of a gas user type, a work order type, a work order urgency, or work order correlation information.

The gas work order refers to a pending task related to gas operation. For example, the gas work order may include a task such as gas device fault repair, maintenance, pipeline network inspection, and a gas user service. The gas work order may be created according to an actual need. For example, a gas manager may create the gas work order based on an input manner of a terminal device (e.g., an application) according to the actual situation.

In some embodiments, the smart gas management platform may generate the gas work order based on user feedback information and monitoring information of a gas pipeline network. Related descriptions may be found in FIG. 1 and descriptions thereof.

The target gas work order refers to a gas work order waiting for statement. The smart gas management platform may obtain the target gas work order from a smart gas data center based on retrieval.

The work order information may include basic information of the work order, such as a work order serial number, processing content, a handler, and a creation time. In some embodiments, the work order information may include the gas user type, the work order type, the work order urgency, the work order correlation information, or any combination thereof.

The gas user type may include an industrial gas user, a commercial gas user, and a general gas user. The work order type may include a plurality of preset work order types according to actual needs, such as repair of a pipeline network device fault, repair of an indoor device fault, gas pipeline maintenance, gas meter installation, and gas user consultation.

The work order urgency refers to a degree to which the gas work order needs to be processed and completed in a timely manner. The work order urgency may be expressed in various forms. For example, the work order urgency may be an integer value from 0 to 10, and the larger the value is, the higher the urgency may be.

The work order correlation information refers to correlation information between the target gas work order and other gas work orders. For example, the correlation information may include that two gas work orders are two child-parent work orders (e.g., a plurality of child-gas work orders of a target gas work order), that two gas work orders are work orders with a sequence of procedures (e.g., work orders that may only be executed after the target gas work order is completed), that two gas work orders are work orders assigned according to a preset assignment relationship (e.g., a plurality of gas work orders under a same set of tasks), etc. The work order correlation information may further include whether two gas work orders use same repair materials (e.g., use a same certain type of repair devices and tools), whether two gas work orders are in a same region, location, etc., which is not limited in the present disclosure.

The work order information may further include other information. For example, the gas work order may further include a processing progress (e.g., the gas work order is not started, the gas work order is processing, and the gas work order is completed), a processing progress value (e.g., 10%, 50%, and 100%), a completion status (e.g., the gas work order is not completed and the gas work order is completed), a statement status (e.g., statement of the gas work order is not completed and statement of the gas work order is completed), etc.

In some embodiments, the work order information of all gas work orders may be stored in the smart gas data center. The smart gas management platform may obtain the work order correlation information of the target gas work order from the smart gas data center through retrieval (e.g., database retrieval).

In 220, a statement demand degree of the target gas work order may be determined based on the work order information.

Statement may characterize a state that the target gas work order has been processed and confirmed to be completed.

The statement demand degree refers to a demand degree for timeliness of statement and accuracy of statement data. The statement demand degree may be a value within an interval of [0, 1], and the larger the value is, the higher the statement demand degree may be.

In some embodiments, the smart gas management platform may determine the statement demand degree of the target gas work order according to the work order information of the target gas work order. For example, different statement demand degrees may be pre-configured according to different gas user types, work order types, work order urgencies, and work order correlation information in the work order information.

For example, for the target gas work order of which the gas user type is an industrial gas user, the statement demand degree may be higher than that of a gas work order of which the gas user type is an ordinary gas user. As another example, for the target gas work order of the repair type of the pipeline network device fault, the statement demand degree may be set higher than a statement demand degree of a gas work order of a gas meter installation type. As another example, the higher the work order urgency is, the higher the statement demand degree of the target gas work order may be. As another example, the greater the count of other work orders correlated with the work order correlation information is, the higher the statement demand degree of the target gas work order may be.

The smart gas management platform may also determine the statement demand degree by conducting a comprehensive evaluation based on the user type, the work order type, the work order urgency, the work order correlation information of the target gas work order, any combination thereof. For example, weights of the gas user type, the work order type, the work order urgency, and the work order correlation information may be set separately, and the statement demand degree of the target gas work order may be determined by weighted summation, etc.

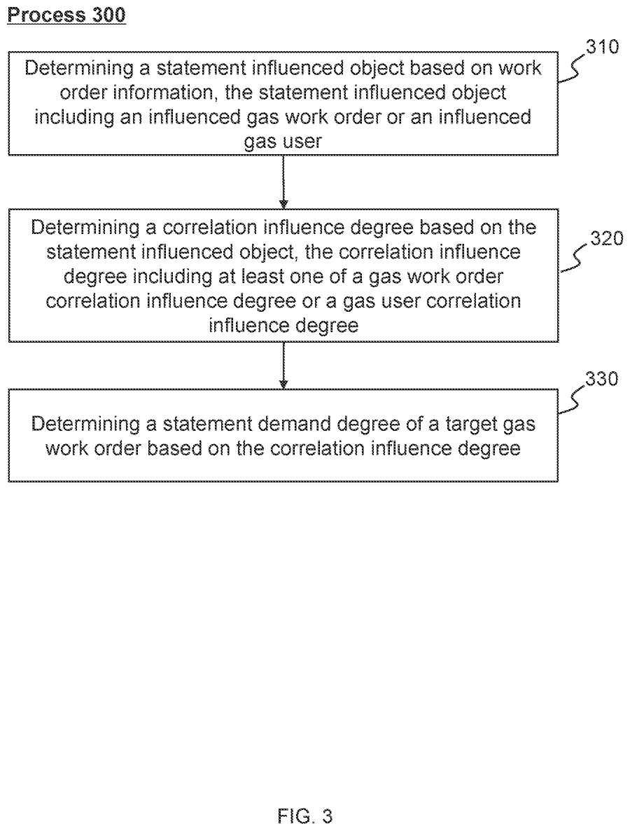

In some embodiments, the smart gas management platform may determine the statement demand degree of the target gas work order based on a correlation influence degree of the work order. More descriptions may be found in FIG. 3 and descriptions thereof.

In 230, a target statement parameter may be determined based on the statement demand degree, the target statement parameter including at least one of a statement mode, a statement time limit, or a statement verification parameter.

The target statement parameter refers to a rule of the target gas work order that is actually used for statement.

The target statement parameter may include a statement mode. The statement mode may include automatic platform statement, confirmation of statement only by a handler, confirmation of statement only by a user, and confirmation of statement by a handler and a user.

The target statement parameter may include the statement time limit. For example, the statement time limit may be 3:00 pm on a same day, 10:00 a.m. this Friday, etc.

The target statement parameter may further include the statement verification parameter. The statement verification parameter may include a verification frequency and a verification intensity. The verification frequency may be a count of verifications within a preset period of time (e.g., one day); the verification intensity refers to an intensity of a reminder of the statement (e.g., reminder modes with different intensities such as App message push, SMS notification, telephone voice notification, announcement).

The target statement parameter is merely for the purposes of illustration, and the target statement parameter may further include other preset parameters.

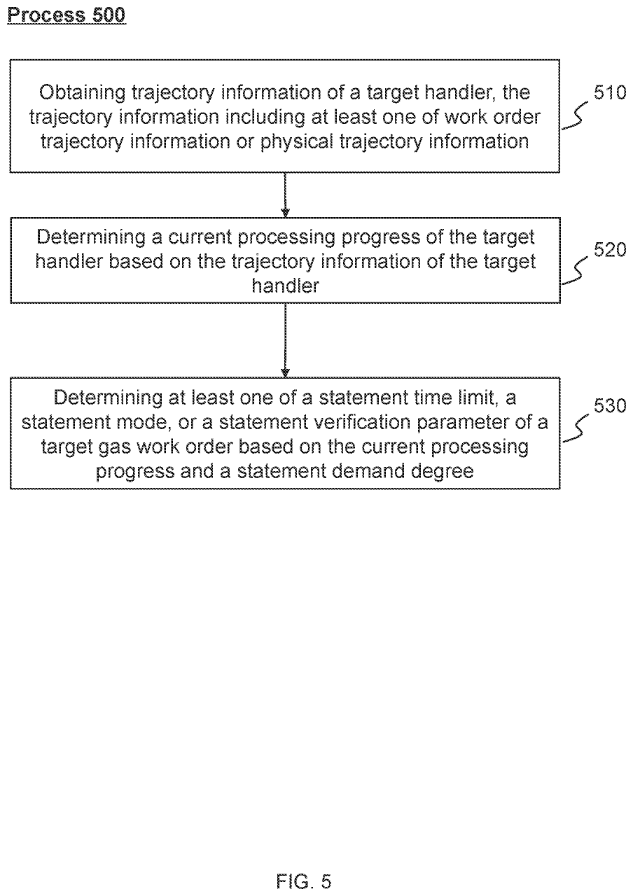

In some embodiments, the smart gas management platform may determine the statement parameter of the target gas work order based on the statement demand degree of the target gas work order. More descriptions about determining the statement parameter of the target gas work order may be found in FIG. 5 and descriptions thereof.

In 240, statement verification may be performed for a target handler based on the target statement parameter.

The target handler refers to a handler corresponding to the target gas work order. The statement verification may be used to indicate an operation that checks the statement status of the target handler. For example, whether the target handler has processed the statement within the statement time limit may be checked based on the statement time limit of the target statement parameter. If the target handler does not process the statement within the statement time limit, the target handler may be reminded according to the verification intensity in the statement verification parameter.

In some embodiments, the smart gas management platform may check and process one or more target gas work orders regularly or irregularly, and may perform statement verification processing on the corresponding target handler according to the target statement parameter of each target gas work order. Exemplarily, the gas work order in the smart gas data center may be checked based on a preset time point (e.g., 9:00 every morning) or a preset time interval (e.g., every 3 hours).

In some embodiments, the smart gas management platform may sort the statement demand degree of each gas work order (e.g., in a descending order), and may perform key statement verification on the statement parameters of the top-ranked gas work orders. For example, the handler of the target gas work order may be reminded (e.g., SMS reminder, telephone notification, etc.) according to the verification frequency and the reminder intensity in the statement parameter of each gas work order.

In some embodiments of the present disclosure, the finally obtained target statement parameter may be more in line with the actual situation in combination with the information of the target gas work order. Besides, the labor and time costs of manual check may be reduced by automatic verification of the statement status through the smart gas management platform. In addition, the automatic statement verification can greatly improve the management efficiency of gas work orders.

FIG. 3 is a flowchart illustrating an exemplary process for determining a statement demand degree of a target gas work order according to some embodiments of the present disclosure.

In some embodiments, the process 300 may be performed by a smart gas management platform. As shown in FIG. 3, the process 300 may include the following operations.

In 310, a statement influenced object may be determined based on work order information, the statement influenced object including an influenced gas work order or an influenced gas user.

The statement influenced object refers to a subject to which an influence relationship occurs due to a state of incomplete statement of a target gas work order. The influence relationship may characterize a negative impact that occurs when the statement of the target gas work order is not completed (or the target gas work order is not completed), which may be a direct influence relationship, or an indirect influence relationship. For example, if a gas work order Order 1 is only performed when the statement of the target gas work order is completed (or the target gas work order is completed), the gas work order Order 1 may be the statement influenced object of the target gas work order, and the gas work order Order 1 and the target gas work order may have the direct influence relationship. As another example, if a gas work order Order 2 is performed when the statement of the gas work order Order 1 is completed, the gas work order Order 2 may also become the statement influence object of the target gas work order, and the gas work order Order 2 and the target gas work order may have the indirect influence relationship.

It can be understood that the statement influenced object of the target gas work order may be an influenced subject chain, which may be one or more influenced subjects.

In some embodiments, the statement influenced object may include the influenced gas work order. The influenced gas work order refers to a gas work order to which the influence relationship occurs due to the state of incomplete statement of the target gas work order.

In some embodiments, the statement influenced object may include the influenced gas user. The influenced gas user refers to a gas user to which the influence relationship occurs due to the state of incomplete statement of the target gas work order. For example, for a target gas work order of a repair type of a gas pipeline fault, when the gas pipeline fault is repaired, it may be necessary to shut down the gas of a region to which the gas pipeline belongs, and the gas users within a gas outage range may be the influenced gas users.

In some embodiments, the smart gas management platform may determine the statement influenced object according to the work order information of the target gas work order and other gas work orders. For example, the smart gas management platform may take a gas work order having a correlation relationship with the target gas work order as the influenced gas work order; and take a relevant gas user within an execution position or region of the target gas work order as the influenced gas user. The correlation relationship (e.g., child-parent work orders, work orders with a sequence of procedures, etc.) may be determined based on the work order correlation information of the target gas.

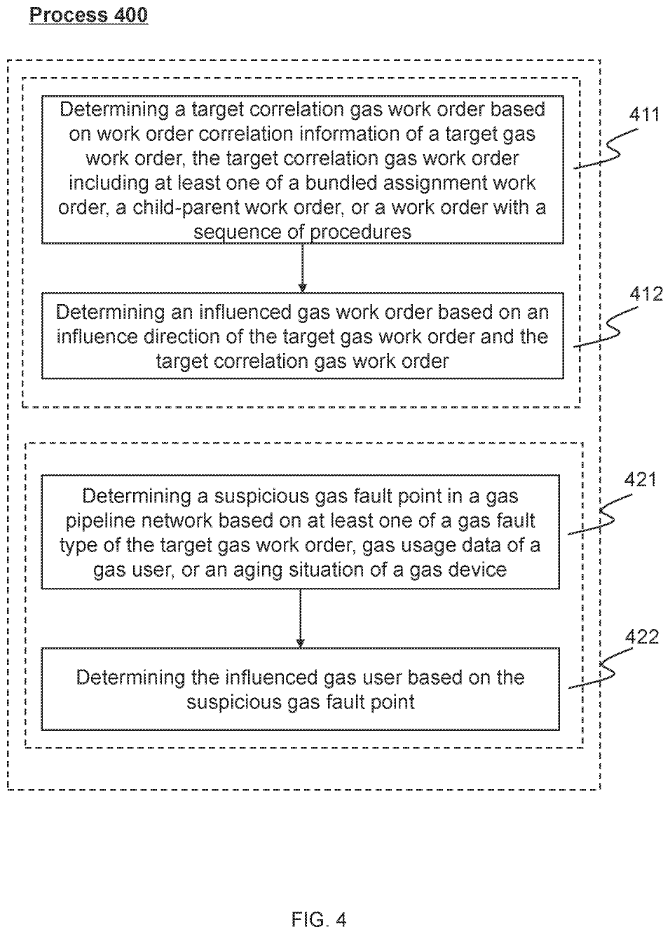

In some embodiments, the smart gas management platform may determine the influenced gas work order based on an influence direction of the correlated gas work order and determine the influenced gas user based on a suspicious gas fault point. More descriptions may be found in FIG. 4 and descriptions thereof.

In 320, a correlation influence degree may be determined based on the statement influenced object, the correlation influence degree including at least one of agas work order correlation influence degree or a gas user correlation influence degree.

The correlation influence degree may be used to characterize a degree of influence of the target gas work order on the influenced gas work order or the influenced gas user. The correlation influence degree may be in the form of a numerical value, and the larger the value is, the greater the correlation influence degree may be.

In some embodiments, the correlation influence degree may be determined based on a count of the influenced gas work orders or a count of the influenced gas users. For example, the correlation influence degree may be a sum of the counts of influenced gas work orders or the influenced gas users.

In some embodiments, the influenced gas work orders and the influenced gas users may have different weight coefficients for the determination of the correlation influence degree. The smart gas management platform may preset the weight coefficients (e.g., 0.4 and 0.6, respectively) of a gas work order correlation influence degree and gas user correlation influence degree, and obtain the correlation influence degree of the target gas work order by performing weighted summation according to the counts of the influenced gas work orders and the influenced gas users.

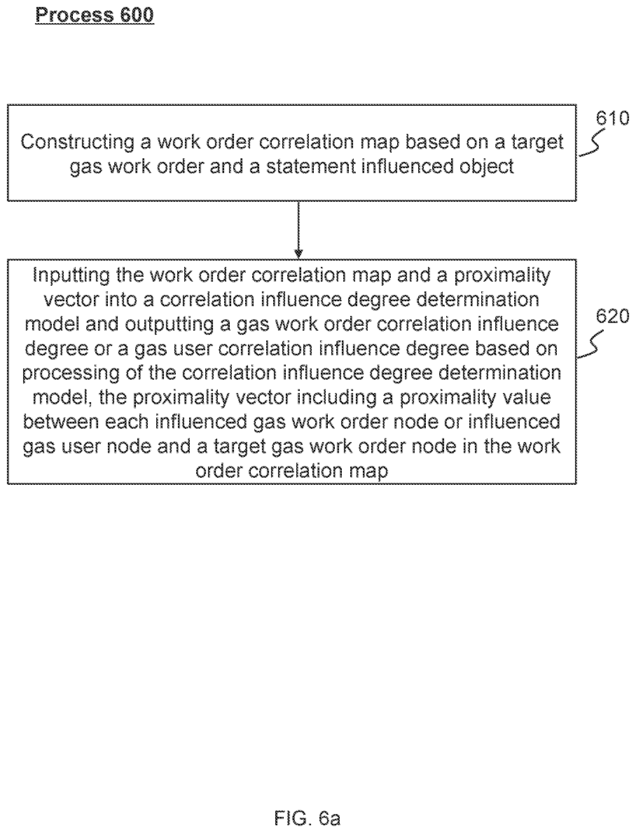

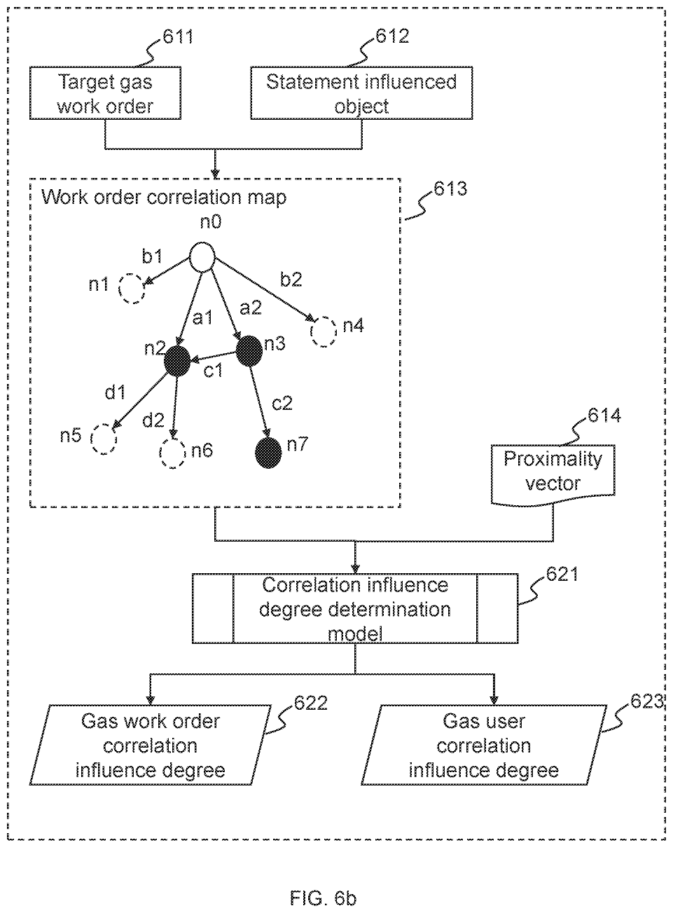

In some embodiments, the smart gas management platform may determine the correlation influence degree of the target gas work order based on a correlation influence degree determination model. More descriptions about a work order correlation map and the correlation influence degree determination model may be found in FIG. 6a and FIG. 6b and descriptions thereof.

In 330, the statement demand degree of the target gas work order may be determined based on the correlation influence degree.

In some embodiments, the greater the correlation influence degree is, the higher the statement demand degree of the target gas work order may be.

In some embodiments of the present disclosure, the statement demand degree may be more in line with the actual situation by evaluating the statement demand degree by introducing the influenced gas work order and the influenced gas user.

FIG. 4 is a flowchart illustrating an exemplary process for determining a statement influenced object of a target gas work order according to some embodiments of the present disclosure.

In some embodiments, the process 400 may be performed by a smart gas management platform. As shown in FIG. 4, the process 400 may include the following operations. The influenced gas work order in the statement influenced object may be determined based on the following operations 411 and 412; and the influenced gas user in the statement influenced object may be determined based on the following operations 421 and 422. The smart gas management platform may execute in parallel to determine the influenced gas work order and determine the influenced gas user.

In 411, a target correlation gas work order may be determined based on work order correlation information of the target gas work order, the target correlation gas work order including at least one of a bundled assignment work order, a child-parent work order, or a work order with a sequence of procedures.

The target correlation gas work order refers to a gas work order that has a certain degree of correlation with the target gas work order. For example, for rescue of gas pipeline leakage, different persons of an emergency repair team may be responsible for different tasks and operations. If the process includes a gas concentration detection operation, an excavation operation, a gas leakage repair operation, etc., the different operations may have a strong correlation in the process, and different operation results may have a relatively great impact on subsequent operations, for the gas work order of the gas concentration detection operation, the target correlation gas work order may include gas work orders corresponding to the excavation operation and the gas leakage repair operation.

The target gas work order may have different correlation influence degrees on different correlation gas work orders. For example, for two different correlation gas work orders, one of the correlation gas work orders may have a relatively great correlation influence degree with the target gas work order, and the other correlation gas work order may have a relatively small correlation influence degree with the target gas work order. The correlation influence degree may be a pre-evaluated value and may be expressed in the form of a numerical value within an interval of (0, 1). The larger the value is, the greater the correlation influence degree may be.

In some embodiments, the smart gas management platform may use a correlation gas work order of which the degree of influence is greater than a preset influence degree threshold (e.g., 0.5) as the target correlation gas work order of the target gas work order.

In some embodiments, the target correlation gas work order may include a bundled assignment work order, a child-parent work order, a work order with a sequence of procedures, or any combination thereof.

In some embodiments, the smart gas management platform may define a plurality of correlation relationships between various gas work orders. For example, the correlation relationship may include a bundled assignment relationship, a child-parent relationship, and existence of a sequence of procedures relationship. When creating a gas work order, the smart gas management platform may establish the correlation relationship between the gas work order and other existing gas work orders according to an actual situation.

In some embodiments, the smart gas management platform may configure the correlation relationship between various gas work orders through a work order correlation relationship table. The work order correlation relationship table may include a plurality of records. Fields of each record may include identifiers (e.g., a work order id or a work order serial number) of two gas work order and one of the aforementioned correlation relationships. The correlation relationship may be a preset relationship identifier. For example, the bundled assignment relationship, the child-parent relationship, and the existence of a sequence of procedures relationship may be represented by relationship identifiers R1, R2, and R3, respectively.

Exemplarily, for a gas work order O1, a gas work order O2, a gas work order O3, and a gas work order O4, a record in the work order correlation table may be the gas work order O1, the gas work order O2, and R1, which may represent that the gas work order O1 and the gas work order O2 are bundled assignment work orders; another record may be the gas work order O1, the gas work order O4, and R2, which may represent that the gas work order O1 and the gas work order O4 are child-parent work orders.

The smart gas management platform may retrieve the bundled assignment work order, the child-parent work order, and the work order with a sequence of procedures that matches the target gas work order using the work order correlation relationship table. For example, for a target gas work order, when it is necessary to obtain a bundled assignment work order, the smart gas management platform may retrieve in the work order correlation relationship table using the serial number and the relationship identifier R1 of the target gas work order, and use the matched gas work order in the record as the bundled assignment work order of the target gas work order. The child-parent work order and the work order with a sequence of procedures may be obtained in a similar way.

In 412, the influenced gas work order may be determined based on an influence direction of the target gas work order and the target correlation gas work order.

The influence direction refers to a relationship in which the statement of the target gas work order influences or is influenced by the target correlation gas work order. The influence direction may include unidirectional influence, which may characterize a relationship that the target gas work order has an influence on the correlation gas work order when the statement is not completed, but the correlation gas work order has no influence on the target gas work order. For example, as for a target gas work order corresponding to an upstream gas task and a gas work order corresponding to a downstream gas task, the gas work order corresponding to the downstream gas task may belong to the target correlation gas work order of the target gas work order corresponding to the upstream gas task. When the statement of the target gas work order is not completed, the statement of the target correlation gas work order may be influenced, and when the statement of the target correlation gas work order is not completed, the statement of the target gas work order may not be influenced, the influence direction may be the unidirectional influence.

The influence direction may also include bidirectional influence, which may characterize a relationship that incompleted statement of one of the target gas work order and the target correlation gas work order may influence the other of the target gas work order and the target correlation gas work order. For example, if a target task includes a plurality of sub-tasks, the target gas work order corresponding to the target task may correspond to a plurality of sub-gas work orders. Accordingly, when statement of any of the target gas work order and the plurality of sub-gas work orders is not completed, statement of the target gas work order and the plurality of sub-gas work orders may not be completed, which may mean that the influence direction is the bidirectional influence.

In some embodiments, the influence direction of the target gas work order and the target correlation gas work order may be preset during creation. Exemplarily, the work order correlation relationship table may further include an identifier of an influence direction. For example, D1 and D2 may be used to represent the unidirectional influence and bidirectional influence, respectively. If two gas work orders have the unidirectional influence or the bidirectional influence, the identifier of an influence direction may be marked in the corresponding work order correlation relationship table record; and if two gas work orders have no unidirectional influence or no bidirectional influence, the identifier of an influence direction may not be marked.

The smart gas management platform may retrieve the influence direction of the target correlation gas work order matching the target gas work order through the work order correlation relationship table, and then determine the influenced gas work order.

In 421, a suspicious gas fault point in a gas pipeline network may be determined based on at least one of a gas fault type of the target gas work order, gas usage data of a gas user, or an aging situation of a gas device.

The gas fault type may be obtained based on work order information of the target gas work order.

The gas usage data of the gas user and the aging situation of the gas device may be obtained based on the IoT system 100. More descriptions about the IoT system 100 may be found in FIG. 1 and descriptions thereof.

The suspicious gas fault point refers to a position where a gas fault may occur, which may be in the form of latitude and longitude coordinates; the suspicious gas fault point may also be in the form of a preset point identifier according to a structure or a design drawing of the gas pipeline network, such as a point a of the pipeline network, a point b of the pipeline network, etc.

In some embodiments, the smart gas management platform may construct a target gas fault vector based on the gas fault type of the target gas work order, the gas usage data of the gas user, and the aging situation of the gas device, and determine at least one suspicious gas fault point by matching in a vector database based on the target gas fault vector.

The vector database may include a plurality of historical gas fault vectors and fault points corresponding to the plurality of historical gas fault vectors. The historical gas fault vectors may be constructed in the same way as the target gas fault vector. An actual fault point corresponding to each historical gas fault vector may be stored in the vector database.

In some embodiments, the smart gas management platform may calculate a vector distance between the target gas fault vector and each historical gas fault vector in the vector database, and determine several historical gas fault vectors of which the vector distance is smaller than a preset distance threshold as reference gas fault vectors, and then take corresponding several fault points as suspicious gas fault points. The vector distance may include, but is not limited to a Euclidean distance, a cosine distance, a Mahalanobis distance, a Chebyshev distance, a Manhattan distance, etc.

In 422, the influenced gas user may be determined based on the suspicious gas fault point.

In some embodiments, the smart gas management platform may determine the influenced gas user corresponding to each suspicious gas fault point according to one or more suspicious gas fault points.

Exemplarily, the smart gas management platform may take a registered householder corresponding to the suspicious gas fault point (e.g., gas device, etc.) as the influenced gas user. The smart gas management platform may also preset a range threshold (e.g., 10 m or 20 m) and take a gas user within a circular range with the suspicious gas fault point (e.g., a gas pipeline or a pipeline network device) as a center of a circle and the preset range threshold as a radius as the influenced gas user, which is not limited in the present disclosure.

In some embodiments, the influenced gas user may also be related to monitoring data of a gas platform. The gas platform may include a smart gas object platform. More descriptions about the smart gas object platform may be found in FIG. 1 and descriptions thereof.

The monitoring data of the gas platform may include gas usage data such as gas consumption (e.g., average daily consumption, weekly consumption, monthly consumption, etc.) within a preset period of time (e.g., last month or quarter), a gas usage frequency (e.g., average daily gas consumption times), a gas usage duration (e.g., 30 minutes per gas usage), a gas usage time distribution (e.g., morning, noon, or evening) and the gas user. The monitoring data may reflect gas usage habits of the gas user and the degree of influence of the target gas work order on the gas user. Exemplarily, if a certain gas user has no gas usage record recently (e.g., in the last week or month), it may indicate that the target gas work order has minimal influence on the gas user. If the gas usage frequency of the gas user is relatively high, the target gas work order may have a relatively great influence on the gas user.

The smart gas management platform may further evaluate the degree to which each influenced gas user is influenced by the target gas work order based on monitoring data of the influenced gas users, and may remove gas users with relatively small influence on the basis of the originally determined influenced gas users.

In some embodiments of the present disclosure, the result of determining the influenced gas user can be more accurate by introducing the monitoring data of the gas users.

In some embodiments of the present disclosure, the influenced work order may be more accurately obtained by introducing the influence direction; and a potential influenced gas user may be identified by introducing the suspicious gas fault point, thereby making the finally determined influenced gas users more comprehensive.

FIG. 5 is a flowchart illustrating an exemplary process for determining a statement parameter of a target gas work order according to some embodiments of the present disclosure.

In some embodiments, the process 500 may be performed by a smart gas management platform. As shown in FIG. 5, the process 500 may include the following operations.

In 510, trajectory information of a target handler may be obtained, the trajectory information including at least one of work order trajectory information or physical trajectory information.

The trajectory information may characterize an action trajectory of the target handler of performing a task or operation.

The smart gas management platform may obtain the trajectory information of the handler of the target gas work order. The trajectory information may include the work order trajectory information and the physical trajectory information.

The work order trajectory information may characterize specific handling of the target gas work order by the target handler. The work order trajectory information may include a processing time point and a processing item (or processing content) corresponding to the processing time point. For example, the work order trajectory information may include a time sequence composed of a plurality of processing time points within a statement time limit of the target gas work order and the processing items corresponding to the time points. The smart gas management platform may determine the work order trajectory information of the handler through report records of the handler.

The physical trajectory information may characterize an actual position change of the target handler. The physical trajectory information may include a time point and a position information corresponding to the time point. For example, the physical trajectory information may include a time sequence composed of a plurality of time points within the statement time limit of the target gas work order and position coordinates (e.g., latitude and longitude coordinates) corresponding to the time points. The smart gas management platform may determine the physical trajectory information of the handler through positioning information sent by a terminal device of the handler.

The smart gas management platform may also obtain the trajectory information of the target handler based on other manners. For example, the trajectory information may be determined through records of collaborators and feedback from customers.

In 520, a current processing progress of the target handler may be determined based on the trajectory information of the target handler.

The processing progress may include a work order status of the gas work order. The work order status may include to be processed, processing, processed, processed and unconfirmed statement, completed statement, completed and unconfirmed statement, completed and confirmed statement, etc. The work order status may be configured according to an actual need.

In some embodiments, the smart gas management platform may determine the current processing progress of the target gas work order by the target handler based on the work order information of the target gas work order, and the work order trajectory information or physical trajectory information of the target handler.

The smart gas management platform may obtain the work order information of the target gas work order, determine information such as a start time, an end time, a processing item, or a target address of the target gas work order, and determine the current processing progress by performing matching analysis processing on the work order trajectory information or the physical trajectory information. For example, if the start time and the end time of the target gas work order are from 9:00 a.m. to 12:00 noon, the processing item is pipeline maintenance, the target address is a section a of pipeline in a region A, based on the work order trajectory information or the physical trajectory information, the smart gas management platform may determine that the target handler is in the target address after 9:00 in the morning and the current processing progress is processing, and may determine that the target handler leaves a range of the target address before 12:00 and the current processing progress is processed.

The determination of the current processing progress herein is merely provided for the purpose of illustration, and is not intended to be limited herein. For example, the work order information configuration of the target gas work order may be the start and end time points across days, a plurality of processing items, and a plurality of target addresses. The smart gas management platform may perform analysis one by one according to the time sequence, an item sequence, a position sequence in the work order trajectory information or physical trajectory information and the work order information configuration to accurately determine the current processing progress.

In 530, at least one of the statement time limit, the statement mode, or the statement verification parameter of the target gas work order may be determined based on the current processing progress and the statement demand degree.

In some embodiments, the smart gas management platform may determine at least one of the statement time limit, the statement mode, or the statement verification parameter of the target gas work order based on the current processing progress and statement demand degree. More descriptions about the statement time limit, the statement mode, and the statement verification parameter may be found in FIG. 2 and descriptions thereof.

For example, the higher the statement demand degree of the target gas work order is, the shorter the statement time limit may be set. If the current processing progress of the target gas work order is processing, a verification frequency may be set higher and a verification intensity may be set greater (e.g., the reminder mode for the target handler be a telephone reminder with a stronger reminding intensity) in the statement verification parameter. As another example, if the current processing progress is processed and the statement demand degree is relatively high, the statement mode to remind the target handler may be set to confirmation by both the gas user and the handler (e.g., confirmation by the target customer, confirmation by the person in charge, etc.).

The smart gas management platform may dynamically adjust one or a combination of the statement time limit, the statement mode, and the statement verification parameter of the target gas work order according to the current processing progress and statement demand degree, so as to adapt to an actual processing progress of the target gas work order by the target handler and better supervise the statement situation.

In some embodiments, the statement time limit of the target gas work order may also be related to a difference between an estimated completion time and a required completion time of the target gas work order. The estimated completion time may be determined based on the current processing progress of the target handler and a labor-hour requirement of a pending work order.

The estimated completion time refers to an estimated time when the target gas work order is actually completed. The estimated completion time may be in the form of a duration (e.g., 3 hours), a time point (e.g., 10:00 a.m.), etc. In some embodiments, the smart gas management platform may determine the estimated completion time based on the current processing progress of the target handler and the labor-hour requirement of the pending work order. It should be noted that the pending work order here may include the target gas work order, and may also include other pending gas work orders (e.g., gas work orders processed in parallel with the target gas work order). For example, for the target gas work order, the current processing progress is processing (e.g., the progress is 50%), the current time point is 9 a.m., and the labor-hour demand of the pending work order is 3 hours, then the estimated completion time may be 10:30 a.m.

The required completion time may be a preset expected completion time, which may be determined based on the work order information of the target gas work order.

In some embodiments, the greater the difference between the estimated completion time and the required completion time of the target gas work order is, the more the estimated completion time may exceed the required completion time, and the shorter the statement time limit may be set by the smart gas management platform. When the difference is smaller than 0 (i.e., the estimated completion time does not exceed the required completion time), the statement time limit may remain unchanged.

In some embodiments, the required completion time may be related to a creation time of the target gas work order and a gas safety risk coefficient. The gas safety risk coefficient may be determined based on at least one of a gas fault type, an aging situation of a gas device, or a suspicious gas fault point. More descriptions about the suspicious gas fault point may be found in FIG. 4 and descriptions thereof.

Exemplarily, the creation time of the target gas work order may be 9:00 in the morning, and the required completion time of the target gas work order may be 11:00 when the situation is normal or the gas safety risk coefficient is relatively small. If the gas safety risk coefficient is relatively great, the required completion time of the target gas work order may be set earlier, e.g., 10:00.

In some embodiments, the smart gas management platform may determine the gas safety risk coefficient based on at least one of the gas fault type, the aging situation of the gas device, or the suspicious gas fault point. Exemplarily, the gas safety risk coefficients corresponding to different gas fault types may be set. For example, the gas safety risk coefficient may be set greater for pipeline maintenance of a gas leakage type, which has a relatively great potential harm and economic losses; the more serious the aging situation of the gas device, and the greater the instability of the gas device may be, the greater the gas safety risk coefficient; the larger the count of suspicious gas fault points, and the greater the potential influence on residents, the greater the gas safety risk coefficient.

The smart gas management platform may determine the gas safety risk coefficient by comprehensively evaluating the gas safety risk coefficient (e.g., setting weights for weighted summation, etc.) according to the gas fault type, the aging situation of the gas device, the suspicious gas fault point, or any combination thereof.

In some embodiments, when the gas safety risk coefficient is higher, the smart gas management platform may set the statement time limit of the target gas work order to be shorter.

In some embodiments of the present disclosure, the required completion time of the target gas work order may be better controlled by introducing the gas safety risk coefficient, thereby reducing the potential risk caused by the relatively long statement time limit, and helping to set the statement time limit more accurate and in line with the actual situation.

In some embodiments, the statement time limit may also be related to a map complexity of a work order correlation graph. The map complexity may be determined based on a count of edges and nodes of the work order correlation map. The greater the map complexity is, the greater the count of the influenced work orders or the influenced gas users may be, and the shorter the statement time limit may be set. More descriptions about the work order correlation map may be found in FIG. 6b and descriptions thereof.

In some embodiments of the present disclosure, for the statement time limit of the target gas work order, the map complexity of the work order correlation map may be introduced, and the count of the influenced work orders and the influenced users may be considered, thereby making the evaluation of the statement time limit of the target gas work order more in line with the actual situation, and avoiding the potential negative impact caused by the incomplete target gas work order.

In some embodiments, the statement time limit may also be related to a busyness of the target handler. The busyness may be determined based on the trajectory information and information of a pending work order of the target handler.

The busyness may characterize a probability that the target handler may have an overtime statement. The busyness may be in the form of a numerical value within an interval of [0, 1]. The larger the value is, the higher the busyness may be; the busyness may also be in other forms, such as free, generally busy, very busy, etc.

In some embodiments, the smart gas management platform may determine the busyness of the target handler based on the trajectory information and the information of the pending work order of the target handler. The pending work order may be one or more gas work orders (e.g., the target gas work order) assigned in advance to be processed by the target handler. Exemplarily, the smart gas management platform may determine the current processing progress based on the trajectory information of the target handler, and then determine the busyness according to the current processing progress of the target handler, the count of pending work orders, and the demand duration (labor-hour demand) of the pending work orders, etc. For example, if the current processing progress is processing, the larger the count of pending work orders is, the greater the probability of overtime statements appearing in the pending work orders may be, and the higher the busyness may be.

In some embodiments, the higher the busyness of the handler of the target gas work order, the greater the risk probability or risk of a potential overtime statement of the pending work order, the shorter the statement time limit of the target gas work order may be set by the smart gas management platform, so as to ensure that subsequent work orders may be processed in a timely manner.

In some embodiments of the present disclosure, introducing the busyness may make the determined statement time limit more accurate and humanized.

In some embodiments, the smart gas management platform may also evaluate an overtime statement risk of the target gas work order based on the current processing progress of the target handler, the required completion time, and the labor-hour requirement of the target gas work order, and dynamically adjust the statement verification parameter based on the overtime statement risk.

The overtime statement risk may characterize a risk that the statement of the target gas work order exceeds a preset statement time limit. For example, the statement time limit of the target gas work order may be 3:00 p.m. on the same day. If the statement is not completed when the time is close to 3:00 p.m. on the same day, it may represent that the target gas work order has the overtime statement risk.

The smart gas management platform may determine the overtime statement risk based on the current processing progress and a time difference between the required completion time and the current time. If the current processing progress is in a state that the statement is not completed, the smaller the time difference is, the closer the statement time limit may be, and the greater the overtime statement risk may be. The smart gas management platform may configure a time difference threshold (e.g., 10 h, or 24 h), etc. If an actual time difference is greater than the time difference threshold, it may represent that there is sufficient time, and the overtime statement risk is 0; if the actual time difference is equal to the time difference threshold, it may represent that there is the overtime statement risk, and a value of the overtime statement risk may be 0.1. At this time, the smart gas management platform may adjust the statement verification parameter. For example, a system message push may be adjusted to an SMS reminder.

Further, in case of the overtime statement risk, different overtime statement risk values may be set based on the actual time difference. For example, when the actual time difference is 9 h, 8 h, 5 h, 1 h, and 0 h, the overtime statement risk values may be 0.2, 0.3, 0.5, 0.9, and 1 in sequence. 1 may represent that the statement will be overtime. Accordingly, the smart gas management platform may adjust the statement verification parameter according to a real-time overtime statement risk value. For example, the smart gas management platform may increase the verification frequency and gradually increase the verification intensity of the reminder statement of the target handler based on the change in the overtime statement risk value.

In some embodiments, the overtime statement risk value may also be related to a difficulty, a complexity, etc. of the target gas work order. The difficulty and the complexity of the target gas work order may be related to the labor-hour demand of the target gas work order. The larger the labor-hour demand of the target gas work order is, the greater the difficulty and the complexity of the target gas work order may be. The smart gas management platform may dynamically adjust the statement verification parameter according to the difficulty and the complexity. For example, for a same overtime statement risk value, if the difficulty and the complexity are relatively large, the statement verification frequency may be relatively large, and the verification intensity may be relatively strong.

In some embodiments of the present disclosure, the statement verification parameter may be dynamically adjusted by introducing the overtime statement risk coefficient, which can better control the statement status of the target gas work order, strengthen the control of the statement overtime risk of the gas work order, and improve management efficiency.

In some embodiments, the overtime statement risk may also be related to a historical statement record of the target handler.

The historical statement record may be a statement record of the gas work order in a preset periods of time such as the past month or the past half year. The smart gas management platform may obtain the historical statement record of the target handler, and determine a count of overtime statement records based on a manner such as statistics, so as to further determine the overtime statement risk. For example, the greater the count of overtime statement records is or the greater a ratio of the count of overtime statement records is, the greater the overtime statement risk may be.

In some embodiments of the present disclosure, the obtained overtime statement risk values may be more accurate and more in line with the actual situation of the handler by introducing the historical statement record.

In some embodiments of the present disclosure, the real-time processing progress of the handler of the target gas work order may be determined in real time through the trajectory information of the handler, and at the same time, the execution of the work order of the handler may be tracked in real time, which can improve the quality of statement management of the gas work order.

FIG. 6a is a flowchart illustrating an exemplary process for determining a correlation influence degree according to some embodiments of the present disclosure.

In some embodiments, the process 600 may be performed by a smart gas management platform. As shown in FIG. 6a, the process 600 may include the following operations.

In 610, a work order correlation map may be constructed based on a target gas work order and a statement influenced object.

The work order correlation map refers to a knowledge map constructed by the target gas work order and the statement influenced object.

In some embodiments, as shown in FIG. 6a, the smart gas management platform may determine the statement influenced object 612 of the target gas work order 611 based on the target gas work order 611 and construct the work order correlation map 613 based on the target gas work order 611 and the statement influenced object 612. The statement influenced object 612 may include an influenced gas work order and an influenced gas user. More descriptions about the statement influenced object may be found in FIG. 3 and descriptions thereof.

A node of the work order correlation map may include a target gas work order node, an influenced gas work order node, or an influenced gas user node. The target gas work order node may correspond to the target gas work order. The influenced gas work order node may correspond to the influenced gas work order. The influenced gas user node may correspond to the influenced gas user. For the convenience of illustration, the target gas work order node may refer to the target gas work order, the influenced gas work order node may refer to the influenced gas work order, and the influenced gas user node may refer to the influenced gas user, the gas user, etc.

FIG. 6b is schematic diagram illustrating an exemplary process for determining a correlation influence degree according to some embodiments of the present disclosure.

As shown in FIG. 6b, a work order correlation map 613 may include a target gas work order node n0; influenced gas work order nodes (solid nodes): nodes n2, n3, and n7; influenced gas user nodes (nodes indicated by hollow dotted lines): nodes n1, n4, n5, and n6.

It should be noted that the work order correlation map 613 is only exemplary. For example, if an actual influenced object of the target gas work order is an influenced gas work order, and there is no influenced gas user, the work order correlation map 613 may only include the target gas work order node and several influenced gas work order nodes; If the actual influenced object of the target gas work order is the influenced gas user, and there is no influenced gas work order, the work order correlation map 613 may only include the target gas work order node and several influenced gas user nodes.

The node of the work order correlation map may include a plurality of preset node features. The node feature of the node may include a node category feature, and a distance feature between the node and the target gas work order.

The node category may include a target gas work order category, an influenced gas work order category, and an influenced gas user node category. The distance between the node and the target gas work order may characterize a distance (e.g., a walking distance, a road distance) between an execution location of the target gas work order and an execution location of the influenced gas work order or the influenced gas user. It can be understood that, for the target gas work order node, the distance feature may be 0.

The work order correlation map may include a plurality of edges. The work order correlation map may include a first type of edge, a second type of edge, a third type of edge, and a fourth type of edge.

The first type of edge may be used to connect the target gas work order node and the influenced gas work order node, indicating a direct influence relationship between the target gas work order and the influenced gas work order.

The second type of edge may be used to connect the target gas work order node and the influenced gas user node, indicating a direct influence relationship between the target gas work order and the influenced gas user.

The third type of edge may be used to connect two influenced gas work order nodes, indicating that the two influenced gas work orders may be the target correlation gas work orders of the target gas work order, and there may be a correlation relationship (e.g., a bundled assignment relationship, a child-parent relationship, or existence of a sequence procedures relationship) between the two influenced gas work orders. More descriptions about the target correlation gas work order and the correlation relationship may be found in FIG. 4 and descriptions thereof.

The fourth type of edge may be used to connect the influenced gas work order node and the influenced gas user node, indicating a direct influence relationship between the influenced gas work order and the influenced gas user.

As shown in FIG. 6b, the work order correlation map 613 may include the first type of edges a1 and a2; the second type of edges b1 and b2; the third type of edges c1 and c2; and the fourth type of edges d1 and d2.

The edge may include a feature of the edge. The feature of the edge may include a degree of influence, which may be used to represent the degree of influence between two nodes connected by the edge. The degree of influence may include a degree of influence on gas work order statement or a degree of influence on gas usage of the gas user.

In some embodiments, the edge features of the first type of edge and the third type of edge related to the influenced gas work order node may include the degree of influence on gas work order statement, which may be used to characterize a degree of influence on statement of each target correlation gas work order when the statement of the target gas work order is not completed.

The degree of influence on gas work order statement may be determined based on an interval between the required completion times and work order urgencies of two adjacent nodes. In some embodiments, the shorter the interval between the required completion times is and the higher the work order urgencies are, the higher the degree of influence on the gas work order statement may be. More descriptions about the work order urgencies may be found in FIG. 2 and descriptions thereof.

In some embodiments, the edge features of the second type of edge and the fourth type of edge related to the influenced gas user node may include a degree of influence on gas usage of the gas user, which may be used to characterize a degree influence on the gas usage of the influenced gas user when the statement of the target gas work order is not completed.

The degree of influence on gas usage of the gas user may be determined based on an influence duration of gas usage (e.g., 30 min, 2 h) and gas usage of the influenced gas users. In some embodiments, the longer the influence duration is, the greater the influence degree value may be; in terms of gas usage, the greater the gas consumption of the influenced gas user is and the higher the frequency of gas usage of the influenced gas user is, the greater the influence degree value may be.

The gas usage of the gas user may be determined based on monitoring data of the gas platform. More descriptions about the gas usage of the gas user may be found in FIG. 4 and descriptions thereof.

In some embodiments, the degree of influence on gas usage of the gas user may also include a superimposed gas usage influence degree. The superimposed gas usage influence degree may be determined based on the degree of influence of the target correlation gas work order of the target gas work order.

The superimposed gas usage influence degree may characterize the usage of the influenced gas user is influenced by the target correlation gas work order in addition to the target gas work order. As shown in FIG. 6b, if the statement of the target gas work order n0 is not completed, an influence may be caused on the influenced gas user n5 and influenced gas user n6. Besides, since the statement of the target gas work order n0 is not completed, the statement of the influenced gas work order n2 may not be completed, which may further influence the influenced gas user n5 and influenced gas user n6 (e.g., extended gas outage time, etc.).

In some embodiments, the smart gas management platform may determine the final degree of influence on the gas usage the gas user based on the comprehensive evaluation of the influence degree of the target gas work order on the gas user and the superimposed gas usage influence degree.

In some embodiments of the present disclosure, the degree of influence on gas usage of the influenced gas user may be evaluated by introducing the superimposed gas usage influence degree, so that the result of the degree of influence on gas usage of the influenced gas user may be more accurate when the statement of the finally determined target gas work order is not completed.

In some embodiments, the feature of the node may further include a gas safety risk coefficient of a gas work order. For example, a feature of the target gas work order node may include a gas safety risk coefficient of the target gas work order; a feature of the influenced gas work order node may include a gas safety risk coefficient of the influenced gas work order. More descriptions about the gas safety risk coefficient may be found in FIG. 5 and descriptions thereof.

In 620, the work order correlation map and a proximality vector may be input into a correlation influence degree determination model, and a gas work order correlation influence degree or a gas user correlation influence degree may be output based on processing of the correlation influence degree determination model, the proximality vector including a proximality value between the each influenced gas work order node or influenced gas user node and the target gas work order node in the work order correlation map.

The correlation influence degree determination model refers to a model used to determine a correlation influence degree of the target gas work order. In some embodiments, the correlation influence degree determination model may be a trained machine learning model. For example, the correlation influence degree determination model may include a recurrent neural network model, a convolutional neural network, other customized model structures, or the like, or any combination thereof.

In some embodiments, the correlation influence determination model may be a trained graph neural network model. As shown in FIG. 6b, the smart gas management platform may input the work order correlation map 613 and the proximality vector 614 into the correlation influence degree determination model 621 and output the gas work order correlation influence degree 622 and/or the gas user correlation influence degree 623 based on the processing of the correlation influence degree determination model 621.

The proximality vector may be determined based on the work order correlation map. The smart gas management platform may determine the proximality vector according to the proximality value between the each influenced gas work order node or influenced gas user node and the target gas work order node in the work order correlation map 613. The smart gas management platform may determine the proximality value based on a count of edges connected between the each influenced gas work order node or influenced gas user node and the target gas work order node in the work order correlation map.

As shown in FIG. 6b, if a connection route between a node n0 and a node n1 is n0→n1, the proximality value of the node n1 may be 1; there may be two connection routes between the node n0 and a node n6, i.e., n0→n2→n6 and n0→n3→n2→n6, at this time, the proximality value of node n6 may be determined based on a count of edges of the shortest connection route, namely, the proximality value of the node n6 may be 2. It can be understood that the shortest connection route characterizes that the target gas work order node has most direct and most correlated influence on the influenced node (e.g., the influenced gas work order node or the influenced gas user node). Similarly, the proximality vector 614 may be expressed as a vector (1, 1, 1, 1, 2, 2, 2), where values of elements in the proximality vector 614 may respectively represent the proximality value between each node of the nodes n1-n7 and the target gas work order node n0.

It can be understood that the proximality vector may further be used to characterize a map complexity of the work order correlation map. For example, the more the elements in the proximality vector, the wider the range involved by the influenced gas work order or the influenced gas user; the greater the sum of the values of all elements in the proximality vector is, the greater the count of influenced gas work orders or the influenced gas users may be, and the greater the map complexity may be.

In some embodiments, the correlation influence degree determination model may be obtained by training a plurality of labeled sample work order correlation maps and sample proximality vectors thereof. Each sample work order correlation map may be a historical work order correlation map. The sample proximality vector may be obtained based on each sample work order correlation map. A label may be determined based on the gas work order correlation influence degree or the gas user correlation influence degree of the target gas work order node in each sample work order correlation map. For example, if the sample work order correlation map only includes the target gas work order node and the influenced gas work order node, the label may be the gas work order correlation influence degree; if the sample work order correlation map only includes the target gas work order node and the influenced gas user node, the label may be the gas user correlation influence degree; and if the sample work order correlation map includes the target gas work order node, the influenced gas work order node, and the influenced gas user node, the label may be the gas work order correlation influence degree and the gas user correlation influence degree.

When an initial correlation influence degree determination model is trained, the smart gas management platform may input each sample work order correlation map and the corresponding sample proximality vector into the initial correlation influence degree determination model and output the gas work order correlation influence degree or the gas user correlation influence degree of the target gas work order node through the processing of the correlation influence degree determination model based on the target gas work order node of the sample work order correlation map. The smart gas management platform may construct a loss function based on the label of each sample work order correlation map and the output of the correlation influence degree determination model, iteratively update a parameter of the correlation influence degree determination model based on the loss function until a preset condition is satisfied and the training is completed, and obtain a trained correlation influence degree determination model. The preset condition may be that the loss function is smaller than a threshold, converges, or a training period reaches a threshold.

In some embodiments of the present disclosure, the gas work order correlation influence degree and the gas user correlation influence degree of the target gas work order may be quickly determined through the processing of the work order correlation map and the proximality vector by the correlation influence degree determination model, which can reduce the consumption of manpower, material resources, and time of the manual evaluation.

It should be noted that, the above descriptions about the process is provided merely for purpose of illustration, and not intended to limit the scope of application of the present disclosure. Those skilled in the art may make various modifications and alterations to the process under the guidance of the present disclosure. However, such modifications and alterations are still within the scope of the present disclosure.

One of the embodiments of the present disclosure provides a non-transitory computer-readable storage medium storing computer instructions. After reading the computer instructions in the storage medium, a computer may execute the method for platform intelligent statement based on operation of smart gas.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that the present disclosure object requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for platform intelligent statement based on operation of smart gas, implemented by a smart gas management platform of an Internet of Things (IoT) system for platform intelligent statement based on operation of smart gas, comprising:
obtaining work order information of a target gas work order, the work order information including at least one of a gas user type, a work order type, a work order urgency, or work order correlation information;
determining a statement demand degree of the target gas work order based on the work order information;
determining a target statement parameter based on the statement demand degree, the target statement parameter including at least one of a statement mode, a statement time limit, or a statement verification parameter; and
performing statement verification for a target handler based on the target statement parameter.

2. The method of claim 1, wherein the determining a statement demand degree of the target gas work order based on the work order information includes:
determining a statement influenced object based on the work order information, the statement influenced object including an influenced gas work order or an influenced gas user;
determining a correlation influence degree based on the statement influenced object, the correlation influence degree including at least one of a gas work order correlation influence degree or a gas user correlation influence degree; and
determining the statement demand degree of the target gas work order based on the correlation influence degree.

3. The method of claim 2, wherein the determining a statement influenced object based on the work order information includes:
determining a target correlation gas work order based on the work order correlation information of the target gas work order, the target correlation gas work order including at least one of a bundled assignment work order, a child-parent work order, or a work order with a sequence of procedures;
determining the influenced gas work order based on an influence direction of the target gas work order and the target correlation gas work order;
determining a suspicious gas fault point in a gas pipeline network based on at least one of a gas fault type of the target gas work order, gas usage data of a gas user, or an aging situation of a gas device; and
determining the influenced gas user based on the suspicious gas fault point.

4. The method of claim 2, wherein the determining a correlation influence degree based on the statement influenced object includes:
constructing a work order correlation map based on the target gas work order and the statement influenced object, a node of the work order correlation map including a target gas work order node, an influenced gas work order node, or an influenced gas user node; an edge of the work order correlation map being used to connect the target gas work order node with the influenced gas work order node or the influenced gas user node; a feature of the node including a node category and a distance between the each node and the target gas work order node; a feature of the edge including a degree of influence, and the degree of influence being related to an influence duration of gas usage of the influenced gas user, gas usage of the influenced gas user, an interval between required completion times and work order urgencies of adjacent influenced gas work orders; and
inputting the work order correlation map and a proximality vector into a correlation influence degree determination model and outputting the gas work order correlation influence degree or the gas user correlation influence degree based on processing of the correlation influence degree determination model, the proximality vector including a proximality value between the each influenced gas work order node or influenced gas user node and the target gas work order node in the work order correlation map.

5. The method of claim 4, wherein the degree of influence further includes a superimposed gas usage influence degree, and the superimposed gas usage influence degree is determined based on the degree of influence of the target correlation gas work order of the target gas work order.

6. The method of claim 4, wherein the feature of the node further includes a gas safety risk coefficient of a gas work order, and the gas work order includes the target gas work order and the influenced gas work order.

7. The method of claim 1, wherein the determining a target statement parameter based on the statement demand degree includes:
obtaining trajectory information of a target handler, the trajectory information including at least one of work order trajectory information or physical trajectory information;
determining a current processing progress of the target handler based on the trajectory information of the target handler; and
determining at least one of the statement time limit, the statement mode, or the statement verification parameter of the target gas work order based on the current processing progress and the statement demand degree.

8. The method of claim 7, wherein the statement time limit is further related to a difference between an estimated completion time and a required completion time of the target gas work order, and the estimated completion time is determined based on the current processing progress of the target handler and a labor-hour demand of a pending work order; and the required completion time is related to a creation time of the target gas work order and a gas safety risk coefficient, and the gas safety risk coefficient is determined based on at least one of a gas fault type, an aging situation of a gas device, or a suspicious gas fault point.

9. The method of claim 7, wherein the statement time limit is further related to a map complexity of the work order correlation map, and the map complexity is determined based on a count of edges and nodes of the work order correlation map.

10. The method of claim 7, wherein the statement time limit is further related to a busyness of the target handler, and the busyness is determined based on the trajectory information and information of a pending work order of the target handler; and the information of the pending work order includes a status of each pending work order, a labor-hour demand of each pending work order, and a required completion time of each pending work order.

11. The method of claim 7, further including:
evaluating an overtime statement risk of the target gas work order based on the current processing progress of the target handler, the required completion time of the target gas work order, and the labor-hour demand of the target gas work order; and
dynamically adjusting the statement verification parameter of the target gas work order based on the overtime statement risk.

12. The method of claim 11, wherein the overtime statement risk is further related to a historical statement record of the target handler.

13. An Internet of Things (IoT) system for platform intelligent statement based on operation of smart gas, comprising a smart gas user platform, a smart gas service platform, a smart gas management platform, a smart gas sensor network platform, and a smart gas object platform, wherein
the smart gas management platform is configured to:
obtain work order information of a target gas work order, the work order information including at least one of a gas user type, a work order type, a work order urgency, or work order correlation information;
determine a statement demand degree of the target gas work order based on the work order information;
determine a target statement parameter based on the statement demand degree, the target statement parameter including at least one of a statement mode, a statement time limit, or a statement verification parameter; and
perform statement verification for a target handler based on the target statement parameter.

14. The IoT system of claim 13, wherein the smart gas user platform includes a gas user sub-platform, a government user sub-platform, and a supervision user sub-platform;
the smart gas service platform includes a smart gas usage service sub-platform, a smart operation service sub-platform, and a smart supervision service sub-platform;
the smart gas management platform includes a smart customer service management sub-platform, a smart operation management sub-platform, and a smart gas data center;
the smart gas sensor network platform includes a gas indoor device sensor network sub-platform and a gas pipeline network device sensor network sub-platform; and
the smart gas object platform includes a gas indoor device object sub-platform and a gas pipeline network device object sub-platform.

15. The IoT system of claim 13, wherein the smart gas management platform is further configured to:
determine a statement influenced object based on the work order information, the statement influenced object including an influenced gas work order or an influenced gas user;
determine a correlation influence degree based on the statement influenced object, the correlation influence degree including at least one of a gas work order correlation influence degree or a gas user correlation influence degree; and
determine the statement demand degree of the target gas work order based on the correlation influence degree.

16. The IoT system of claim 15, wherein the smart gas management platform is further configured to:
determine a target correlation gas work order based on the work order correlation information of the target gas work order, the target correlation gas work order including at least one of a bundled assignment work order, a child-parent work order, or a work order with a sequence of procedures;
determine the influenced gas work order based on an influence direction of the target gas work order and the target correlation gas work order;
determine a suspicious gas fault point in a gas pipeline network based on at least one of a gas fault type of the target gas work order, gas usage data of a gas user, or an aging situation of a gas device; and
determine the influenced gas user based on the suspicious gas fault point.

17. The IoT system of claim 15, wherein the smart gas management platform is further configured to:
construct a work order correlation map based on the target gas work order and the statement influenced object, a node of the work order correlation map including a target gas work order node, an influenced gas work order node, or an influenced gas user node; an edge of the work order correlation map being used to connect the target gas work order node with the influenced gas work order node or the influenced gas user node; a feature of the node including a node category and a distance between the each of the nodes and the target gas work order node; a feature of the edge including a degree of influence, and the degree of influence being related to an influence duration of gas usage of the influenced gas user, gas usage of the influenced gas user, an interval between required completion times and the work order urgencies of adjacent influenced gas work orders; and
input the work order correlation map and a proximality vector into a correlation influence degree determination model and outputting the gas work order correlation influence degree or the gas user correlation influence degree based on processing of the correlation influence degree determination model, the proximality vector including a proximality value between the each influenced gas work order node or the influenced gas user node and the target gas work order node in the work order correlation map.

18. The IoT system of claim 13, wherein the smart gas management platform is further configured to:
obtain trajectory information of a target handler, the trajectory information including at least one of work order trajectory information or physical trajectory information;
determine a current processing progress of the target handler based on the trajectory information of the target handler; and
determine at least one of the statement time limit, the statement mode, or the statement verification parameter of the target gas work order based on the current processing progress and the statement demand degree.

19. The IoT system of claim 18, wherein the smart gas management platform is further configured to:
evaluate an overtime statement risk of the target gas work order based on the current processing progress of the target handler, the required completion time of the target gas work order, and the labor-hour demand of the target gas work order; and
dynamically adjust the statement verification parameter of the target gas work order based on the overtime statement risk.

20. A non-transitory computer-readable storage medium storing computer instructions, wherein after reading the computer instructions in the storage medium, a computer executes the method for platform intelligent statement based on operation of smart gas of claim 1.
